(19) United States
(12) Patent Application Publication
(10) Pub. No.: US 2012/0130759 A1
(43) Pub. Date: May 24, 2012

(54) SYSTEM AND METHOD FOR RISK OPTIMIZED, SPATIALLY SENSITIVE PREVENTIVE MAINTENANCE SCHEDULING FOR ASSET MANAGEMENT

(75) Inventors: Andrew J. Davenport, Brooklyn, NY (US); Arun Hampapur, Norwalk, CT (US); Shilpa N. Mahatma, Mohegan Lake, NY (US); Lexing Xie, White Plains, NY (US)

(73) Assignee: INTERNATIONAL BUSINESS MACHINES CORPORATION, Armonk, NY (US)

(21) Appl. No.: 12/954,051

(22) Filed: Nov. 24, 2010

(51) Int. Cl. G06Q 10/00; G06F 17/30

(52) U.S. Cl. 705/7.12; 707/802; 707/E17.005

(57) ABSTRACT

A preventative maintenance method and a system for estimating the risk of failure of an asset based on intrinsic parameters such as failure history combined with causative factors like weather and independent external risk factors such as vandalism and risk of flooding. The present invention may further have a system for estimating the risk of failure of an asset based on intrinsic parameters, such as failure history combined with causative factors such as weather and independent external risk factors like vandalism and risk of flooding having a location based asset/service failure risk estimator, an external risk estimates database for feeding and an integrated failure risk database, the external risk estimates database feeding the integrated failure risk database.

### RELATED APPLICATIONS

The present application is related in some aspects to commonly owned and co-pending application entitled “INFRASTRUCTURE ASSET MANAGEMENT”, having Attorney Docket No. END920100156US1, and U.S. patent application Ser. No. [TO BE PROVIDED], filed on [TO BE PROVIDED], and commonly owned and co-pending application entitled “A SYSTEM AND METHOD FOR FAILURE ASSOCIATION ANALYSIS”, having Attorney Docket No. END920100158US1, and U.S. patent application Ser. No. [TO BE PROVIDED], filed on [TO BE PROVIDED].

### FIELD OF THE INVENTION

One aspect of the present invention provides for a method and a system for estimating the risk of failure of an asset based on intrinsic parameters, such as failure history or causative factors like weather and independent external risk factors like vandalism and risk of flooding. The failure risk is combined with location information to generate maintenance schedules which are optimal with reference to failure risk and inspection cost.

There is a need to provide for large scale preventive maintenance in a easy, computerized manner for large assets.

### BACKGROUND OF THE INVENTION

There is a problem in preventive maintenance. Preventive Maintenance is a critical and costly operation in large scale asset based business. Today, preventive maintenance is carried out at regular time intervals on all assets (meaning that, as an example, all 10,000 fire hydrants in Washington, D.C., need to be checked twice a year), irrespective of the risk of failure. Given the magnitude of the task, it is very expensive and by not factoring failure risk into the inspection process it is sub-optimal from the perspective of minimizing outages.

What is needed is a system and method for estimating the risk of failure of an asset based on intrinsic parameters, such as failure history combined with causative factors and independent external risk factors like vandalism and risk of flooding.

Therefore, there exists a need for a solution that solves at least one of the deficiencies of the related art.

### SUMMARY OF THE INVENTION

The present invention may comprise a system and method for estimating the risk of failure of an asset based on intrinsic parameters, such as failure history combined with causative factors like weather and/or independent external risk factors such as vandalism and risk of flooding. The failure risk estimation is combined with location information to generate maintenance schedules that are optimal with reference to failure risk and inspection cost.

The present invention may further comprise a method for preventative maintenance comprising estimating the risk of failure of an asset, combining the estimation with causative factors, determining a preventative maintenance schedule and storing the preventative maintenance schedule.

The present invention may further comprise a system for estimating the risk of failure of an asset based on intrinsic parameters, such as failure history combined with causative factors such as weather and independent external risk factors like vandalism and risk of flooding, the system comprising a location based asset/service failure risk estimator, an external risk estimates database for feeding, and an integrated failure risk database, the external risk estimates database feeding the integrated failure risk database.

The present invention may further comprise a computer-readable medium storing computer instructions, which, when executed, enables a computer system operating for estimating the risk of failure of an asset based on intrinsic parameters, such as failure history combined with causative factors such as weather and independent external risk factors like vandalism and risk of flooding, the system comprising a location based asset/service failure risk estimator, an external risk estimates database for feeding and an integrated failure risk database, the external risk estimates database feeding the integrated failure risk database for implementing a method for preventative maintenance comprising estimating the risk of failure of an asset, combining the estimation with causative factors, determining a preventative maintenance schedule and storing the preventative maintenance schedule.

The present invention may further include a method for deploying a system for estimating the risk of failure of an asset based on intrinsic parameters, such as failure history combined with causative factors such as weather and independent external risk factors like vandalism and risk of flooding, the system comprising a location based asset/service failure risk estimator, an external risk estimates database for feeding, and an integrated failure risk database, the external risk estimates database feeding the integrated failure risk database, the method comprising estimating the risk of failure of an asset, combining the estimation with causative factors, determining a preventative maintenance schedule and storing the preventative maintenance schedule.

The present invention may further comprise a system for estimating the risk of failure of an asset based upon intrinsic parameters, such as failure history combined with causative factors like weather and independent external risk factors like vandalism and risk of flooding, the system comprising a location based asset/service failure risk estimator, an external risk estimates database for feeding, and an integrated failure risk database, the external risk estimates database feeding the integrated failure risk database.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a data processing system suitable for estimating the risk of failure of an asset based on intrinsic parameters such as failure history combined with causative factors like weather and/or independent external risk factors like vandalism and risk of flooding of the present invention.

FIG. 2 shows a network that may incorporate an embodiment of the present invention.

FIG. 3 illustrates a system of the present invention for estimating the risk of failure of an asset based on intrinsic parameters, such as failure history combined with causative factors like weather and/or independent external risk factors like vandalism and risk of flooding.

FIG. 4 illustrates a method of the present invention for estimating the risk of failure of an asset based on intrinsic parameters, such as failure history combined with causative factors like weather and/or independent external risk factors like vandalism and risk of flooding.

The drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE DRAWINGS

The present invention, which meets the needs identified above, provides for a method and a system for estimating the risk of failure of an asset based on: 1) intrinsic parameters, such as failure history combined with causative factors such weather; and 2) independent external risk factors like vandalism and risk of flooding.

The asset management software of the present invention provides insight for enterprise assets, their conditions and work processes, for better planning and control.
Manages asset deployment, specifications, monitoring, calibration, costing and tracking from a single system;
Provides enterprise asset management software for long and short-term planning, preventive, reactive and condition-based maintenance, schedule management, resource optimization and key performance indicators;
Plans inventory to meet maintenance demand, making the right parts available at the right location when needed;
Manages vendor contracts with comprehensive support for purchase, lease, rental, warranty, rate, master, blanket and user-defined contracts; and
Aligns service levels with business objectives by defining service offerings and establishing service level agreements (SLAs).

The present invention may be used in airports, rail and transit, marine, ports and terminals, hospitality such as hotels, casinos and amusement parks, water and waste water management, mining/metals/minerals, oil and gas, aerospace and defense, food and beverage, electronics and industrial, automotive, retail, life sciences, federal (civil and defense) and state, NASA, healthcare, education, banking and securities, media and cable, telecommunications, insurance, and service providers.

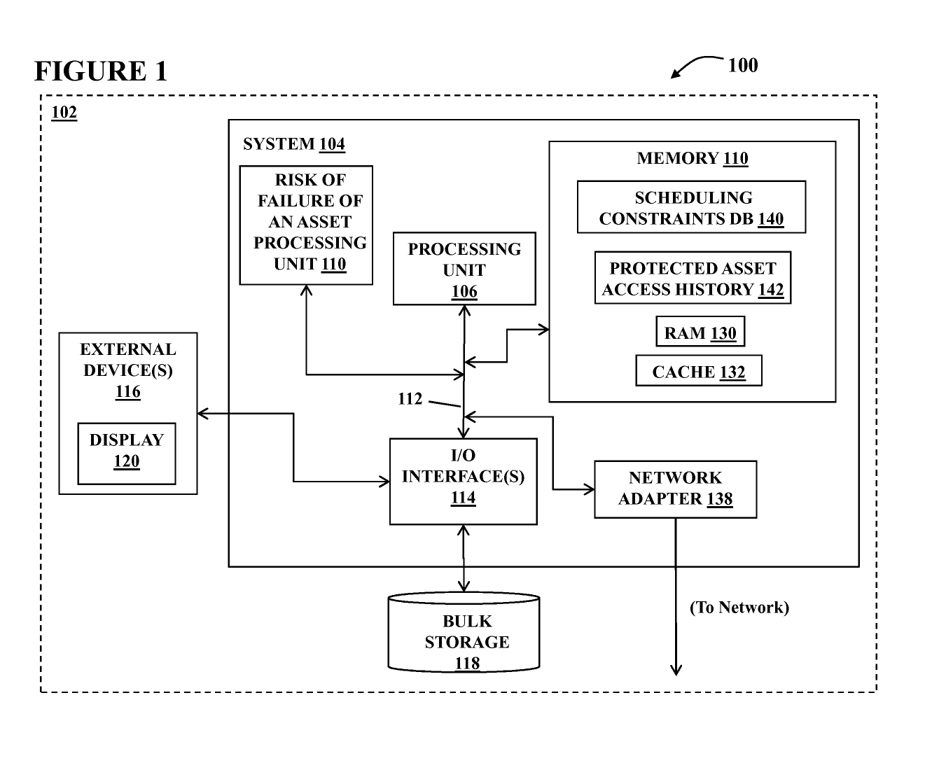

System 100, such as Data Processing System 102 shown in FIG. 1, suitable for storing and/or executing program code of the present invention may include System 104 having at least one processor (Processing Unit 106) and Risk of Failure of an Asset Processing Unit 111 coupled directly or indirectly to Memory 110 through System Bus 112. Memory 110 may include local memory (RAM 130) employed during actual execution of the program code and cache memories (Cache 132) that provide temporary storage of at least some program code in order to reduce the number of times code must be retrieved from Bulk Storage 118, connected to Scheduling Constraints Database 140, during execution. Memory 110 may further include External Risk Estimates Database 142 for collecting and storing the external risks estimates of an asset based on: 1) intrinsic parameters, such as failure history combined with causative factors such weather; and 2) independent external risk factors like vandalism and risk of flooding.

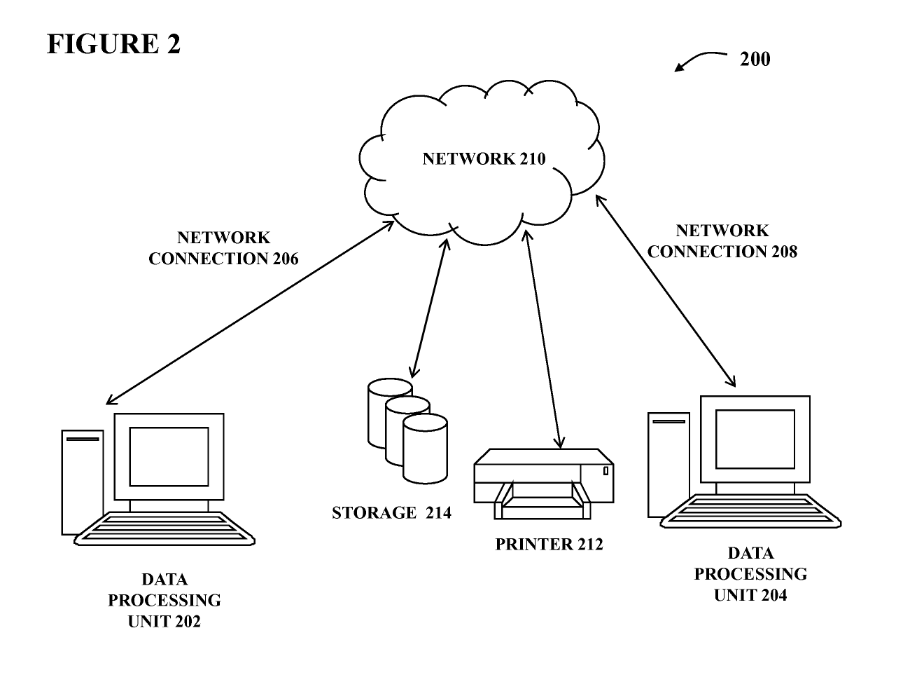

Input/output or I/O devices (External Peripherals 116) (including but not limited to keyboards, displays (Display 120), pointing devices, etc.) can be coupled to System 104 (see FIG. 1), either directly or indirectly through a network (see FIG. 2) through intervening I/O controllers (I/O interface(s) 114).

Network adapters (Network Adapter 138 in FIG. 1) may also be utilized in System 200 to enable data processing units (as shown in FIG. 2, Data Processing Unit 202) to become coupled through network connections (Network Connections 206, 208) to other data processing units (Data Processing Unit 204), remote printers (Printer 212) and/or storage devices (Storage 214) or other devices through intervening private and/or public networks (Network 210).

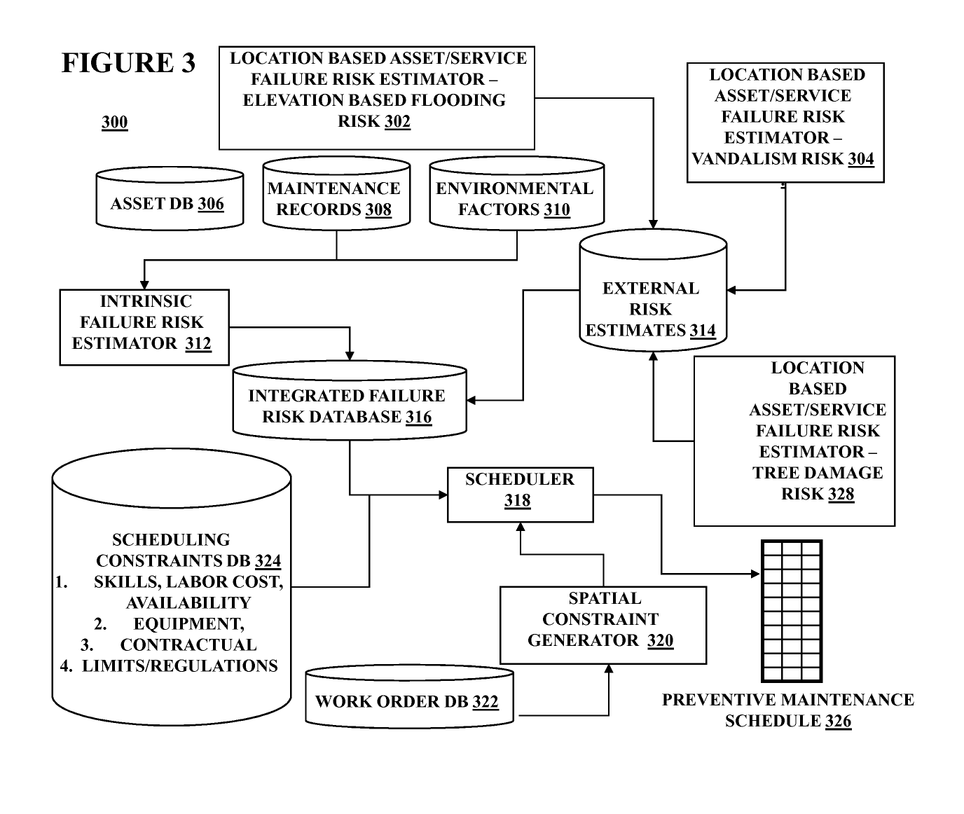

FIG. 3 illustrates System 300 for estimating the risk of failure of an asset based on: 1) intrinsic parameters, such as failure history combined with causative factors such as weather; and 2) independent external risk factors like vandalism and risk of flooding. System 300 has a Location Based Asset/Service Failure Risk Estimator—Elevation Based Flooding Risk element 302. It further has Location Based Asset/Service Failure Risk Estimator—Vandalism Risk element 304. Both are connected to an External Risk Estimates database 314 that feeds an Integrated Failure Risk Database 316. System 300 further has Asset Database 306, Maintenance Database 308 and Environment Factors Database 310 all connected to Intrinsic Failures Risk Estimator 312. Intrinsic Failures Risk Estimator 312 is also connected to Integrated Failure Risk Database 316. Location Based Asset/Service Failure Risk Estimator—Tree damage Risk Element 328 feeds External Risk Estimates Database 314.

Integrated Failure Risk Database 316 is connected to Scheduler 318. Also connected to Scheduler 318 is Scheduling Constraints Database 324 which maintains data such as skills, labor cost, availability; equipment; and contractual limits/regulations. Also feeding Scheduler 318 is Spatial Constraint Generator 320. Work Order Database 322 feeds Spatial Constraint Generator 320. Scheduler 318 loads Risk Optimized, Spatially Sensitive Preventive Maintenance Schedule database 326.

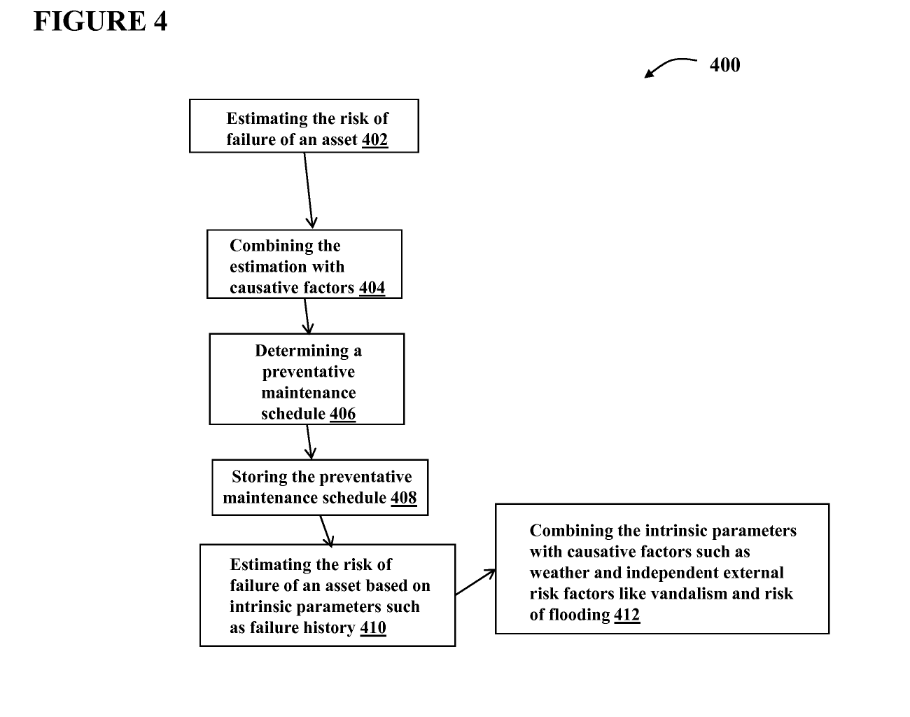

FIG. 4 illustrates one method 400 of the present invention. At 402, the method estimates the risk of failure of an asset. At 404, the method combines the estimation with causative factors. At 406, the next step is to determine a preventative maintenance schedule. At 408, the next step is to store the preventative maintenance schedule. At 410, the next step of the method is to estimate the risk of failure of an asset based on intrinsic parameters such as failure history. And finally, at 412, the last step is to combine the intrinsic parameters with causative factors such as weather and independent external risk factors like vandalism and risk of flooding, as an example.

It should be understood that the present invention is typically computer-implemented via hardware and/or software. As such, client systems and/or servers will include computerized components as known in the art. Such components typically include (among others) a processing unit, a memory, a bus, input/output (I/O) interfaces, external devices, etc.

While shown and described herein as a system and method for estimating the risk of failure of an asset based on: 1) intrinsic parameters—like failure history combined with causative factors like weather; and 2) independent external risk factors like vandalism and risk of flooding. For example, in one embodiment, the invention provides a computer-readable/useable medium that includes computer program code to enable a system for collecting and maintaining historical party reputation data and for using the historical party reputation data to calculate an access decision rating and recalculating the access decision rating when the historical party reputation data has changed has a reputation updater for updating a reputation. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a computer-implemented method for estimating the risk of failure of an asset based on: 1) intrinsic parameters—like failure history combined with causative factors like weather; and 2) independent external risk factors like vandalism and risk of flooding. In this case, a computerized infrastructure can be provided and one or more systems for performing the process steps of the invention can be obtained (e.g., created, purchased, used, modified, etc.) and deployed to the computerized infrastructure. To this extent, the deployment of a system can comprise one or more of (1) installing program code on a computing device, such as computer system from a computer-readable medium; (2) adding one or more computing devices to the computer infrastructure; and (3) incorporating and/or modifying one or more existing systems of the computer infrastructure to enable the computerized infrastructure to perform the process steps of the invention.

As used herein, it is understood that the terms “program code” and “computer program code” are synonymous and may mean any expression, in any language, code or notation, of a set of instructions intended to cause a computing device having an information processing capability to perform a particular function either directly before or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

In another embodiment, the invention provides a business method that performs the process steps of the invention on a subscription, advertising, and/or fee basis. That is, a service provider, such as a solution integrator, could offer to deploy a computer infrastructure for collecting and maintaining historical party reputation data and for estimating the risk of failure of an asset based on: 1) intrinsic parameters—like failure history combined with causative factors like weather; and 2) independent external risk factors like vandalism and risk of flooding. In this case, the service provider can create, maintain, and support, etc., the computer infrastructure by integrating computer-readable code into a computing system, wherein the code in combination with the computing system is capable of performing the process steps of the invention for one or more customers. In return, the service provider can receive payment from the customer(s) under a subscription and/or fee agreement and/or the service provider can receive payment from the sale of advertising content to one or more third parties.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for preventative maintenance comprising:
estimating the risk of failure of an asset;
combining the estimation with causative factors;
determining a preventative maintenance schedule; and
storing the preventative maintenance schedule.

2. The method as defined in claim 1 further comprising estimating the risk of failure of an asset based on intrinsic parameters such as failure history.

3. The method as defined in claim 2 further comprising combining the intrinsic parameters with causative factors such as weather and independent external risk factors like vandalism and risk of flooding.

4. A system for estimating the risk of failure of an asset based on intrinsic parameters, such as failure history combined with causative factors such as weather and independent external risk factors like vandalism and risk of flooding, the system comprising:
a location based asset/service failure risk estimator;
an external risk estimates database for feeding; and
an integrated failure risk database, the external risk estimates database feeding the integrated failure risk database.

5. The system as defined in claim 4 wherein the location based asset/service failure risk estimator further comprises an elevation based flooding risk element.

6. The system as defined in claim 5 wherein the location based asset/service failure risk estimator further comprises a vandalism risk element.

7. The system as defined in claim 6 further comprising an asset database, a maintenance database and environment factors database all connected to the intrinsic failures element.

8. The system as defined in claim 7 further comprising an intrinsic failures element also connected to integrated failure risk database.

9. The system as defined in claim 8 further comprising a location based asset/service failure risk estimator.

10. The system as defined in claim 9 further comprising a tree damage risk element that feeds external risk estimates database.

11. A computer-readable medium storing computer instructions, which, when executed, enables a computer system operating for estimating the risk of failure of an asset based on intrinsic parameters, such as failure history combined with causative factors such as weather and independent external risk factors like vandalism and risk of flooding, the system comprising a location based asset/service failure risk estimator, an external risk estimates database for feeding and an integrated failure risk database, the external risk estimates database feeding the integrated failure risk database for implementing a method for preventative maintenance comprising:
estimating the risk of failure of an asset;
combining the estimation with causative factors;
determining a preventative maintenance schedule; and
storing the preventative maintenance schedule.

12. The method as defined in claim 11 further comprising estimating the risk of failure of an asset based on intrinsic parameters such as failure history.

13. The method as defined in claim 12 further comprising combining the intrinsic parameters with causative factors such as weather and independent external risk factors like vandalism and risk of flooding.

14. A method for deploying a system for estimating the risk of failure of an asset based on intrinsic parameters, such as failure history combined with causative factors such as weather and independent external risk factors like vandalism and risk of flooding, the system comprising a location based asset/service failure risk estimator, an external risk estimates database for feeding, and an integrated failure risk database, the external risk estimates database feeding the integrated failure risk database, the method comprising:
estimating the risk of failure of an asset;
combining the estimation with causative factors;
determining a preventative maintenance schedule; and
storing the preventative maintenance schedule.

15. The method as defined in claim 14 further comprising estimating the risk of failure of an asset based on intrinsic parameters such as failure history.

16. The method as defined in claim 15 further comprising combining the intrinsic parameters with causative factors such as weather and independent external risk factors like vandalism and risk of flooding.

17. A system for estimating the risk of failure of an asset based upon intrinsic parameters, such as failure history combined with causative factors like weather and independent external risk factors like vandalism and risk of flooding, the system comprising:
a location based asset/service failure risk estimator;
an external risk estimates database for feeding; and
an integrated failure risk database, the external risk estimates database feeding the integrated failure risk database.

18. The system as defined in claim 17 wherein the location based asset/service failure risk estimator further comprises an elevation based flooding risk element.

19. The system as defined in claim 18 wherein the location based asset/service failure risk estimator further comprises a vandalism risk element.

20. The system as defined in claim 19 further comprising an asset database, a maintenance database and environment factors database all connected to the intrinsic failures element.

21. The system as defined in claim 20 further comprising an intrinsic failures element also connected to integrated failure risk database.

22. The system as defined in claim 21 further comprising a location based asset/service failure risk estimator.

23. The system as defined in claim 22 further comprising a tree damage risk element that feeds external risk estimates database.
